(19) United States
(12) Patent Application Publication
(10) Pub. No.: US 2025/0122049 A1
(43) Pub. Date: Apr. 17, 2025

(54) ELEVATOR SYSTEM AND METHOD OF CONTROLLING THE SAME

(71) Applicant: HYUNDAI ELEVATOR CO., LTD., Chungcheongbuk-do (KR)

(72) Inventors: Moonsu Kim, Chungcheongbuk-do (KR); Seungwoo Lee, Chungcheongbuk-do (KR); Dooyeol Lee, Chungcheongbuk-do (KR)

(21) Appl. No.: 18/518,515

(22) Filed: Nov. 23, 2023

(30) Foreign Application Priority Data
Oct. 13, 2023 (KR) 10-2023-0136473

(51) Int. Cl. B66B 1/34; B66B 1/06; B66B 5/00

(52) U.S. Cl. CPC B66B 1/3407; B66B 1/06; B66B 1/3446; B66B 5/0012

(57) ABSTRACT

An elevator system includes one or more elevator lines, an image unit, and a control unit, where each of the elevator lines includes at least one elevator car; the image unit includes a first imaging device installed inside the elevator car and a second imaging device provided to an elevator hall on each floor of a building; the control unit includes a first controller controlling and managing operation of the elevator and a second controller controlling and managing operation of the robots; and each of the elevator lines is operated in any one of a non-robot exclusive mode, a robot exclusive mode, and a boarding-share mode.

### CROSS-REFERENCE TO RELATED APPLICATION

This patent document claims the benefit of Korean Patent Application No. 10-2023-0136473, filed on Oct. 13, 2023, the entire disclosure of which is incorporated by reference for all purposes as if fully set forth herein.

### FIELD

The present invention relates to an elevator system and a method of controlling the same.

### BACKGROUND

An elevator includes an elevator car moving along a hoistway formed inside a building in a vertical direction, a hoist generating power to raise or lower the elevator car, and a power transmission transmitting the power of the hoistway to the elevator car.

An elevator car moves along a hoistway formed inside a building in the vertical direction. An elevator is provided with a motor generating power, a hoistway, and the like to raise or lower the elevator car. One or more elevators installed within the building may be controlled and managed integrally.

The elevators allow robots and/or non-robots, such as persons, cargo, animals and plants, to be moved vertically within the building.

Recently, robots have been used to provide services. However, since commercially available robots can move horizontally and are not designed to move vertically, there is a need for a means to move the robots between floors in buildings.

Therefore, various interlocking control technologies between robots and elevators are developed in the art so as to allow the robots to board the elevators so as to move between the floors in the building.

### Related Literature

### Patent Document

Korean Patent Laid-open Publication No. 10-2022-0139528

### SUMMARY

Embodiments of the present invention have been conceived to solve such problems in the art and it is an aspect of the present invention to provide an elevator system operated based on video information when there is a difference between the number of robots based on location signals sent from robots and the number of robots based on the video information, and a method of controlling the same.

In accordance with one aspect of the present invention, an elevator system includes one or more elevator lines, an image unit, and a control unit, wherein each of the elevator lines includes at least one elevator car; the image unit includes a first imaging device installed inside the elevator car and a second imaging device provided to an elevator hall on each floor of a building; the control unit includes a first controller controlling and managing operation of an elevator and a second controller controlling and managing operation of the robots; and each of the elevator lines is operated in any one of a non-robot exclusive mode, a robot exclusive mode, and a boarding-share mode.

The image unit may transmit, to the first controller, at least one of: the number of robots placed in a specific elevator car; the number of non-robots placed in the specific elevator car; the number of robots placed in all elevator cars on each elevator line; the number of non-robots placed in all elevator cars on each elevator line; the number of robots placed in all elevator cars in the building; and the number of non-robots placed in all elevator cars in the building, as calculated based on image information recognized by the first imaging device.

The image unit may transmit, to the first controller, at least one of: the number of robots waiting in an elevator hall in front of a specific elevator line on a specific floor; the number of non-robots waiting in the elevator hall in front of the specific elevator line on the specific floor; the number of robots waiting in all elevator halls on the specific floor; the number of non-robots waiting in all elevator halls on the specific floor; the number of robots waiting in all elevator halls on each elevator line; the number of non-robots waiting in all elevator halls on each elevator line; the number of robots waiting in all elevator halls in the building; and the number of non-robots waiting in all elevator halls in the building, as calculated based on image information recognized by the second imaging device.

The second controller may transmit, to the first controller, at least one of: the number of robots placed in a specific elevator car; the number of robots placed in all elevator cars on each elevator line; and the number of robots placed in all elevator cars in the building, as calculated based on location signals sent from the robots.

The second controller may transmit, to the first controller, at least one of: the number of robots waiting in an elevator hall in front of a specific elevator line on a specific floor; the number of robots waiting in all elevator halls on the specific floor; the number of robots waiting in all elevator halls on each elevator line; and the number of robots waiting in all elevator halls in the building, as calculated based on location signals sent from the robots.

In accordance with another aspect of the present invention, there is provided a method of controlling the elevator system, wherein the first controller adjusts the number of serviceable robots for each floor of the building based on the number of robots or non-robots received from the image unit, when there is a difference between the number of robots or non-robots received from the image unit and the number of robots or non-robots received from the second controller.

In accordance with a further aspect of the present invention, there is provided a method of controlling the elevator system, wherein the first controller switches an operation mode of the elevator line according to the number of robots or non-robots received from the image unit, when there is a difference between the number of robots or non-robots received from the image unit and the number of robots or non-robots received from the second controller.

In a state that a specific elevator line is operated in the robot exclusive mode, when the number of robots received from the image unit indicates that there is neither a robot waiting in any elevator hall on the entire corresponding elevator line nor a robot placed inside any elevator car on the entire corresponding elevator line for a certain period of time or more, the first controller may switch the corresponding elevator line to the boarding-share mode.

In a state that the corresponding elevator line is switched from the robot exclusive mode to the boarding-share mode by the first controller, when the number of non-robots received from the image unit indicates that there is neither a non-robot waiting in any elevator hall on the entire corresponding elevator line nor a non-robot placed inside any elevator car on the entire corresponding elevator line for a certain period of time or more, the first controller may return the corresponding elevator line from the boarding-share mode to the robot exclusive mode.

In a state that a specific elevator line is operated in the non-robot exclusive mode, when the number of non-robots received from the image unit indicates that there is neither a non-robot waiting in any elevator hall on the entire corresponding elevator line nor a non-robot placed inside any elevator car on the entire corresponding elevator line for a certain period of time or more, the first controller may switch the corresponding elevator line to the boarding-share mode.

In a state that the corresponding elevator line is switched from the non-robot exclusive mode to the boarding-share mode by the first controller, when the number of robots received from the image unit indicates that there is neither a robot waiting in any elevator hall on the entire corresponding elevator line nor a robot placed inside any elevator car on the entire corresponding elevator line for a certain period of time or more, the first controller may return the corresponding elevator line from the boarding-share mode to the non-robot exclusive mode.

According to the embodiments of the present invention, it is possible to achieve efficient traffic handling even in an exceptional situation where the number of robots based on location signals sent from robots is different from the number of robots based on video information.

### BRIEF DESCRIPTION OF THE DRAWINGS

The above and other aspects, features, and advantages of the present invention will become apparent from the detailed description of the following embodiments in conjunction with the accompanying drawings:

FIG. 1 is a schematic diagram illustrating a robot and a non-robot boarding an elevator car;

FIG. 2 is a schematic view of an example of an interior image of an elevator car recognized by a first imaging device installed inside the elevator car;

FIG. 3 is a schematic view of an example of an elevator hall image recognized by a second imaging device provided to an elevator hall;

FIG. 4 is a schematic view of an elevator system according to one embodiment of the present invention;

FIG. 5 is a schematic flowchart illustrating an elevator system control method according to one embodiment of the present invention; and

FIG. 6 is a schematic flowchart illustrating an elevator system control method according to another embodiment of the present invention.

### DETAILED DESCRIPTION

Hereinafter, embodiments of the present invention will be described in detail with reference to the accompanying drawings such that the present invention can be easily implemented by those skilled in the art. The present invention may be applied in various ways to robot and elevator control fields. It should be understood that the present invention may be embodied in different ways and is not limited to the following embodiments.

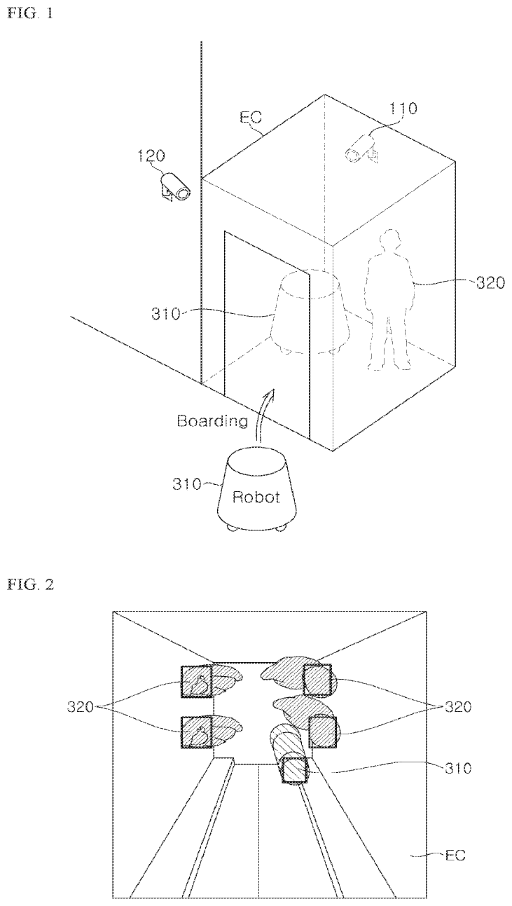

FIG. 1 is a schematic view illustrating a robot 310 and a non-robot 320, such as a human, boarding an elevator car EC.

Referring to FIG. 1, the elevator car EC provided to an elevator system according to the present invention may be loaded with robots 310 as well as non-robots 320, such as persons, cargo, animals, plants, and the like. Herein, the robot 310 will be used as a concept broadly encompassing autonomous, unmanned, and other mechanical devices that move and/or perform tasks automatically or by external control. The robot 310 may be a service robot for providing services on at least one floor within a building.

The elevator car EC may be provided therein with a first imaging device 110 that captures an interior image of the elevator car EC, and an elevator hall (where passengers board and alight from an elevator) on each floor of the building may be provided with a second imaging device 120 that captures an image of the elevator hall.

FIG. 2 is a schematic diagram illustrating an example of an internal image of the elevator car EC recognized by the first imaging device 110 installed inside the elevator car EC. As shown in FIG. 2, the robot 310 and the non-robot 320 boarding the elevator car EC can be recognized by the first imaging device 110.

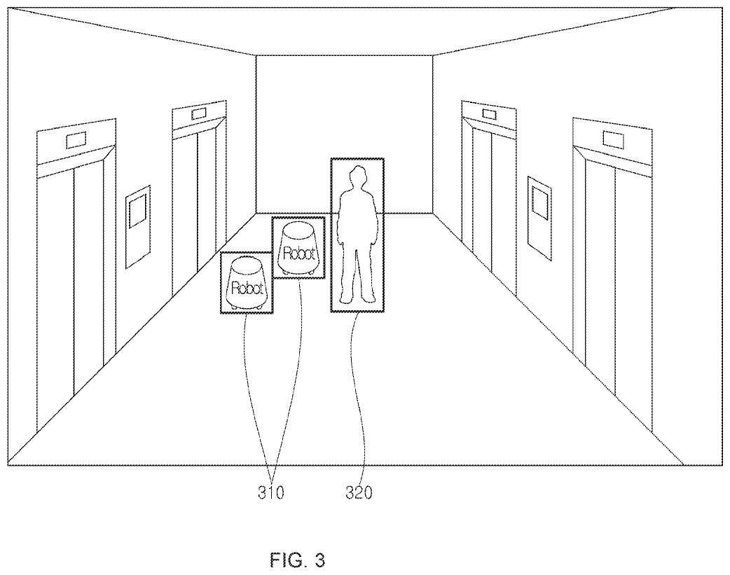

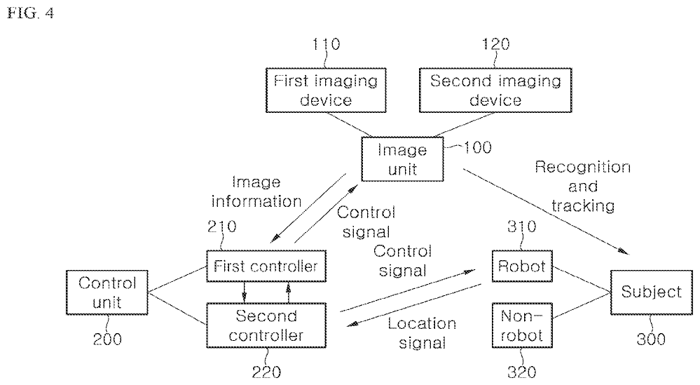

FIG. 3 is a schematic view of an example of an elevator hall image recognized by the second imaging device 120 provided to the elevator hall. As shown in FIG. 3, the robot 310 and the non-robot 320 waiting in the elevator hall can be recognized by the second imaging device 120.

FIG. 4 is a schematic view of an elevator system according to one embodiment of the present invention. Referring to FIG. 4, the elevator system according to this embodiment includes an image unit 100 and a control unit 200.

The image unit 100 may include the first imaging device 110 installed inside the elevator car EC and the second imaging device 120 provided to an elevator hall on each floor of the building. Various devices, such as cameras, CCTVs, and the like, which can recognize images and communicate with the control unit 200, may be used as the first imaging device 110 and the second imaging device 120.

The control unit 200 may include a first controller 210 that controls and manages overall operation of an elevator, and a second controller 220 that controls and manages overall operation of the robots 310.

The image unit 100 recognizes and tracks a subject 300. The subject 300 may include a robot 310 and a non-robot 320, such as a person, cargo, animal or plant. The image unit 100 may adopt machine learning to improve ability to distinguish and detect the subject 300.

The image unit 100 may distinguish, detect, and recognize at least one subject 300 placed inside the elevator car EC by computing image information of the interior of the elevator car EC recognized by the first imaging device 110. The image unit 100 may distinguish, detect, and recognize at least one subject 300 waiting in the elevator hall by computing image information of the elevator hall recognized by the second imaging device 120.

The image unit 100 may transmit, to the first controller 210, at least one of: the number of robots 310 placed inside a specific elevator car EC; the number of non-robots 320 placed inside the specific elevator car EC; the number of robots 310 placed inside all elevator cars EC on each elevator line; the number of non-robots 320 placed inside all elevator cars EC on each elevator line; the number of robots 310 placed inside all elevator cars EC in the building, and the number of non-robots 320 placed inside all elevator cars EC in the building, as calculated based on the image information recognized by the first imaging device 110.

Herein, the elevator line means an identification number set for each hoistway. In addition, although a single elevator line is generally provided with a single elevator car, it should be understood that other implementations are possible and a single elevator line may be provided with multiple elevator cars.

The image unit 100 may transmit, to the first controller 210, at least one of: the number of robots 310 waiting in an elevator hall in front of a specific elevator line on a specific floor; the number of non-robots 320 waiting in the elevator hall in front of the specific elevator line on the specific floor; the number of robots 310 waiting in all elevator halls on the specific floor; the number of non-robots 320 waiting in all elevator halls on the specific floor; the number of robots 310 waiting in all elevator halls on each elevator line; the number of non-robots 320 waiting in all elevator halls on each elevator line; the number of robots 310 waiting in all elevator halls in the building, and the number of non-robots 320 waiting in all elevator halls in the building, as calculated based on the image information recognized by the second imaging device 120.

The first controller 210 may send a control signal to the image unit 100. The first controller 210 may receive image information from the image unit 100. The first controller 210 may perform group management of the elevator. The first controller 210 may include a terminal, a monitoring board, and the like, which perform monitoring of the elevator.

The second controller 220 may send a control signal to the robots 310. The second controller 220 may receive location signals from the robots 310. The second controller 220 may monitor travel paths of the robots 310 based on the location signals sent from the robots 310. The second controller 220 may determine, based on the location signals sent from the robots 310, whether the robot 310 is placed inside the elevator car EC and whether the robot 310 is waiting in the elevator hall.

The second controller 220 may transmit, to the first controller 210, at least one of: the number of robots 310 placed inside a specific elevator car EC, the number of robots 310 placed inside all elevator cars EC on each elevator line, and the number of robots 310 placed inside all elevator cars EC in the building, as computed based on the location signals sent from the robots 310.

The second controller 220 may transmit, to the first controller 210, at least one of: the number of robots 310 waiting in an elevator hall in front of a specific elevator line on a specific floor, the number of robots 310 waiting in all elevator hall on the specific floor, the number of robots 310 waiting in all elevator halls on each elevator line, and the number of robots 310 waiting in all elevator halls in the building, as computed based on the location signals sent from the robots 310.

According to the present invention, it is possible to achieve efficient traffic handling even in an exceptional situation where the number of robots based on a location signal sent from a robot is different from the number of robots based on image information. To this end, the first controller 210 may compare the number of robots 310 received from the image unit 100 with the number of robots 310 received from the second controller 220. When the number of robots 310 received from the image unit 100 is different from the number of robots 310 received from the second controller 220, the first controller 210 may prioritize the number of robots 310 received from the image unit 100 to determine that the number of robots 310 received from the image unit 100 is an actual number of robots 310, and may adjust the number of serviceable robots 310 on each floor of the building. This will be described with reference to some examples as follows.

(1) In the case where the number of robots 310 waiting in all elevator halls in the building is different

1) When the number of robots 310 received from the image unit 100 is less than the number of robots 310 received from the second controller 220

The first controller 210 may adjust the number of serviceable robots 310 on each floor to the number of robots 310 received from the image unit 100 to allocate an optimal elevator line to an elevator hall in which the robot 310 sends a new call.

Accordingly, when the number of robots 310 received from the second controller 220 indicates that the number of serviceable robots 310 exceeds a preset limit and the number of robots 310 received from the image unit 100 indicates that the number of serviceable robots 310 does not exceed the preset limit, it is possible to prevent the first controller 210 from determining that the number of serviceable robots 310 exceeds the preset limit even though the number of serviceable robots 310 does not actually exceed the preset limit. Furthermore, it is possible to prevent unnecessary distributed allocation of the elevator cars based on the assumption that, although the number of serviceable robots 310 does not actually exceed the preset limit, it is determined that the number of serviceable robots 310 exceeds the preset limit.

2) When the number of robots 310 received from the image unit 100 is greater than the number of robots 310 received from the second controller 220

The first controller 210 may adjust the number of serviceable robots 310 on each floor to the number of robots 310 received from the image unit 100 to prevent the number of serviceable robots 310 from exceeding the preset limit on some floor sections during a call service for the robot 310.

Accordingly, when the number of robots 310 received from the second controller 220 indicates that the number of serviceable robots 310 does not exceed the preset limit and the number of robots 310 received from the image unit 100 indicates that the number of serviceable robots 310 exceeds the preset limit, it is possible to prevent the first controller 210 from determining that the number of serviceable robots 310 does not exceed the preset limit even though the number of serviceable robots 310 actually exceeds the preset limit. Furthermore, the elevator system can prevent overcrowding of the robots 310 inside the elevator car EC by ensuring that distributed allocation of the elevator cars is achieved.

(2) In the case where the number of robots 310 placed inside all elevator cars EC in the building is different

1) When the number of robots 310 received from the image unit 100 is less than the number of robots 310 received from the second controller 220

The first controller 210 may adjust the number of serviceable robots 310 on each floor to the number of robots 310 received from the image unit 100 to allocate an optimal elevator line to an elevator hall in which the robot 310 sends a new call.

Accordingly, when the number of robots 310 received from the second controller 220 indicates that the number of serviceable robots 310 exceeds a preset limit and the number of robots 310 received from the image unit 100 indicates that the number of serviceable robots 310 does not exceed the preset limit, it is possible to prevent the first controller 210 from determining that the number of serviceable robots 310 exceeds the preset limit even though the number of serviceable robots 310 does not actually exceed the preset limit.

2) When the number of robots 310 received from the image unit 100 is greater than the number of robots 310 received from the second controller 220

The first controller 210 may adjust the number of serviceable robots 310 on each floor to the number of robots 310 received from the image unit 100 to prevent the number of serviceable robots 310 from exceeding a preset limit on some floor sections during a call service for the robot 310.

Accordingly, when the number of robots 310 received from the second controller 220 indicates that the number of serviceable robots 310 does not exceed the preset limit and the number of robots 310 received from the image unit 100 indicates that the number of serviceable robots 310 exceeds the preset limit, it is possible to prevent the first controller 210 from determining that the number of serviceable robots 310 does not exceed the preset limit even though the number of serviceable robots 310 actually exceeds the preset limit.

The elevator line may be operated in one of the following three modes.

### 1) Non-Robot Exclusive Mode

In this mode, only the non-robot 320, such as a person and the like, is allowed to board the elevator car EC and the elevator line is assigned only in response to a call from the non-robot 320 without assignment of the elevator line in response to a call from the robot 310.

### 2) Robot Exclusive Mode

In this mode, only the robot 310 is allowed to board the elevator car EC and the elevator line is assigned only in response to a call from the robot 310 without assignment of the elevator line in response to a call from the non-robot 320, such as a person and the like.

### 3) Boarding-Share Mode

In this mode, both the robot 310 and the non-robot 320 are allowed to board the elevator car EC, and the elevator line is allocated in response to a call from the robot 310 or a call from the non-robot 320, such as a person and the like.

The first controller 210 compares the number of robots 310 received from the image unit 100 with the number of robots 310 received from the second controller 220 and may switch the operation mode of the elevator line based on the number of robots 310 received from the image unit 100, when the number of robots 310 received from the image unit 100 is different from the number of robots 310 received from the second controller 220. This will be described with reference to some examples as follows.

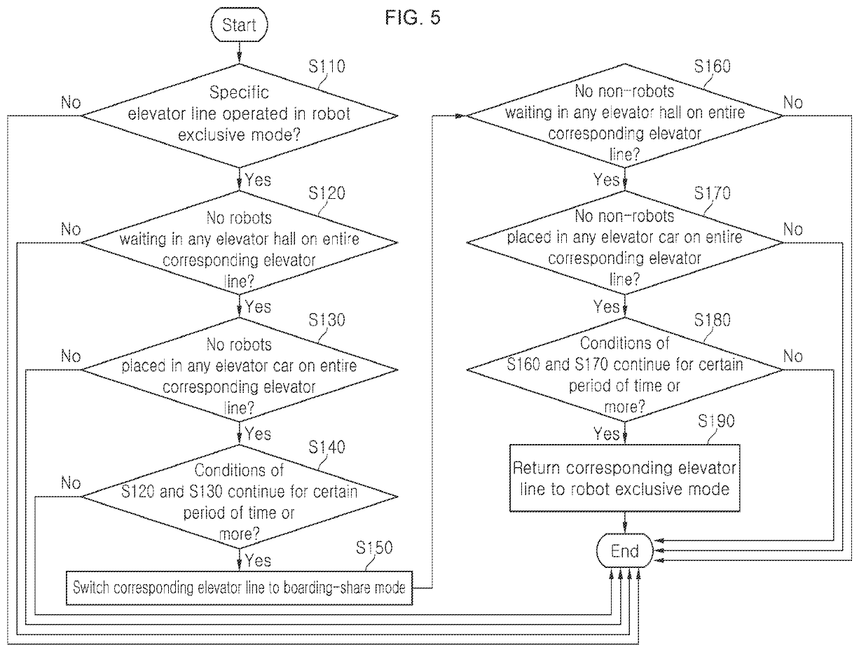

FIG. 5 is a schematic flowchart illustrating an elevator system control method according to one embodiment of the present invention. Hereinafter, the elevator system control method will be described with reference to FIG. 5.

(Case 1) In a state that a specific elevator line is operated in the robot exclusive mode (S110), the number of robots 310 received from the image unit 100 indicates that (1) there is no robot 310 waiting in any elevator hall on the entire corresponding elevator line (S120), (2) there is no robot 310 placed in any elevator car EC on the entire corresponding elevator line (S130), and (3) this condition continues for a “certain period of time” or more (S140)

In Case 1, the first controller 210 switches the corresponding elevator line to the boarding-share mode (S150) to allow the corresponding elevator line to be allocated not only in response to a call from the robot 310 but also in response to a call from the non-robot 320, such as a person and the like.

Accordingly, it is possible to improve efficiency in traffic handling through improvement in inefficiency that, even though the robot 310 using the corresponding elevator line does not actually exist, the corresponding elevator line is set to the robot exclusive mode to prevent the non-robot 320, such as a person and the like, from using the corresponding elevator line.

Although it is desirable that the operation of the first controller 210 to switch the corresponding elevator line to the boarding-share mode occur automatically when the above condition is satisfied, it should be understood that other implementations are possible. In addition, the “certain period of time” may be a predetermined period of time or an automatically trained period of time. This is identically applied to the following cases.

(Case 2) In a state that the corresponding elevator line is switched from the robot exclusive mode to the boarding-share mode by the first controller 210 (Case 1), the number of non-robots 320 received from the image unit 100 indicates that (1) there is no non-robot 320 waiting in any elevator hall on the entire corresponding elevator line (S160), (2) there is no non-robot 320 placed in any elevator car EC on the entire corresponding elevator line (S170), and (3) this condition continues for a “certain period of time” or more (S180)

Case 2 may include any one of the following three cases:
1) where the number of robots 310 received from the image unit 100 indicates that there is a robot 310 waiting in any elevator hall on the entire corresponding elevator line or a robot 310 placed in any elevator car EC on the entire corresponding elevator line;
2) where the number of robots 310 received from the image unit 100 indicates that there is neither a robot 310 waiting in any elevator hall on the entire corresponding elevator line nor a robot 310 placed in any elevator car EC on the entire corresponding elevator line and this condition continues for a “certain period of time” or more; and
3) where a hall call or a car call is generated from the robot 310.

In Case 2, the first controller 210 returns the corresponding elevator line from the boarding-share mode to the robot exclusive mode (S190) to allow the corresponding elevator line to be allocated only in response to a call from the robot 310 while preventing the corresponding elevator ling from being allocated in response to a call from the non-robot 320, such as a person and the like.

As a result, it is possible to improve efficiency in traffic handling by allowing efficient call services for the robot 310.

Although it is desirable that the operation of the first controller 210 to return the corresponding elevator line to the robot exclusive mode occur automatically when the above condition is satisfied, it should be understood that other implementations are possible.

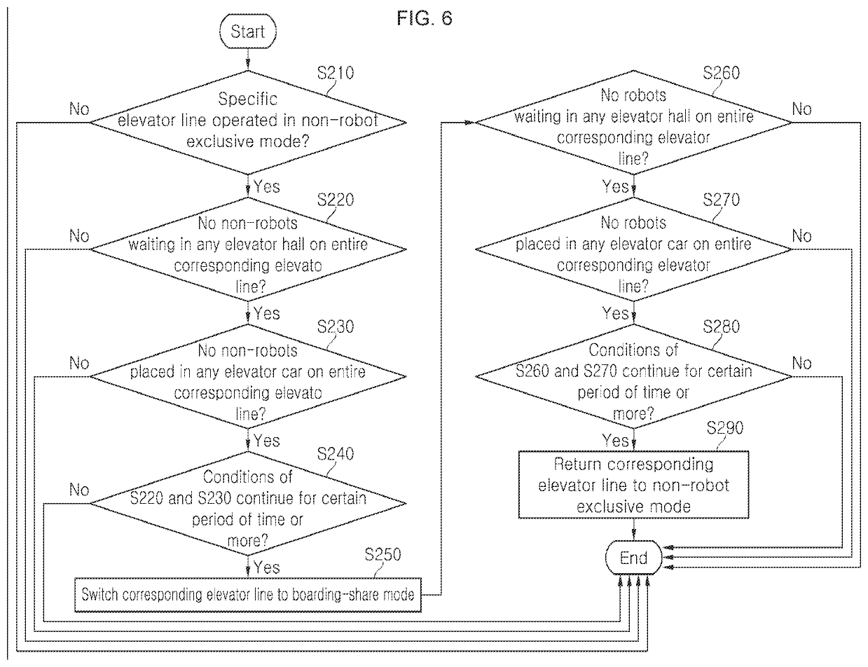

FIG. 6 is a schematic flowchart illustrating an elevator system control method according to another embodiment of the present invention. Hereinafter, the elevator system control method will be described with reference to FIG. 6.

(Case 3) In a state that a specific elevator line is operated in the non-robot exclusive mode (S210), the number of non-robots 320 received from the image unit 100 indicates that (1) there is no non-robot 310, such as a person and the like, waiting in any elevator hall on the entire corresponding elevator line (S220), (2) there is no non-robot 320 placed in any elevator car EC on the entire corresponding elevator line (S230), and (3) this condition continues for a “certain period of time” or more (S240)

The first controller 210 switches the corresponding elevator line to the boarding-share mode (S250) to allow the corresponding elevator line to be allocated not only in response to a call from the non-robot 320, such as a person and the like, but also in response to a call from the robot 310.

Accordingly, it is possible to improve efficiency in traffic handling through improvement in inefficiency that, even though the non-robot 320, such as a person and the like, using the corresponding elevator line does not actually exist, the corresponding elevator line is set to the non-robot exclusive mode to prevent the robot 310 from using the corresponding elevator line.

Although it is desirable that the operation of the first controller 210 to switch the corresponding elevator line to the boarding-share mode occur automatically when the above condition is satisfied, it should be understood that other implementations are possible.

(Case 4) In a state that the corresponding elevator line is switched from the non-robot exclusive mode to the boarding-share mode by the first controller 210 (Case 3), the number of robots 310 received from the image unit 100 indicates that (1) there is no robot 320 waiting in any elevator hall on the entire corresponding elevator line (S260), (2) there is no robot 320 placed in any elevator car EC on the entire corresponding elevator line (S270), and (3) this condition continues for a “certain period of time” or more (S280)

Case 4 may include any one of the following three cases:
1) where the number of non-robots 320 received from the image unit 100 indicates that there is a non-robot 310 waiting in a certain elevator hall on the entire corresponding elevator line or a non-robot 310 placed in a certain elevator car EC on the entire corresponding elevator line;
2) where the number of non-robots 310 received from the image unit 100 indicates that there is neither a non-robot 320 waiting in any elevator hall on the entire corresponding elevator line nor a non-robot 320 placed in any elevator car EC on the entire corresponding elevator line and this condition continues for a “certain period of time” or more; and
3) where a hall call or a car call is generated from the non-robot 310

In Case 4, the first controller 210 returns the corresponding elevator line from the boarding-share mode to the non-robot exclusive mode (S290) to allow the corresponding elevator line to be allocated only in response to a call from the non-robot 320, such as a person and the like while preventing the corresponding elevator line from being allocated in response to a call from the robot 310, such as a person and the like.

As a result, it is possible to improve efficiency in traffic handling by allowing efficient call service for the non-robot 310.

Although it is desirable that the operation of the first controller 210 to return the corresponding elevator line to the non-robot exclusive mode occur automatically when the above condition is satisfied, it should be understood that other implementations are possible.

Although some exemplary embodiments have been described herein, it should be understood that these embodiments are given by way of illustration only and that various modifications, variations, and alterations can be made by those skilled in the art without departing from the spirit and scope of the present invention. Therefore, the scope of the invention should be limited only by the appended claims and equivalents thereto.

<List of Reference Numerals>

| | |
|---|---|
| EC: Elevator car | 100: Image unit |
| 110: First imaging device | 120: Second imaging device |
| 200: Control unit | 210: First controller |
| 220: Second controller | 300: Subject |
| 310: Robot | 320: Non-robot |

1. An elevator system comprising one or more elevator lines, an image unit, and a control unit, wherein:
each of the elevator lines comprises at least one elevator car;
the image unit comprises a first imaging device installed inside the elevator car and a second imaging device provided to an elevator hall on each floor of a building;
the control unit comprises a first controller controlling and managing operation of an elevator and a second controller controlling and managing operation of robots; and
each of the elevator lines is operated in any one of a non-robot exclusive mode, a robot exclusive mode, and a boarding-share mode.

2. The elevator system according to claim 1, wherein the image unit transmits, to the first controller, at least one of: the number of robots placed in a specific elevator car; the number of non-robots placed in the specific elevator car; the number of robots placed in all elevator cars on each elevator line; the number of non-robots placed in all elevator cars on each elevator line; the number of robots placed in all elevator cars in the building; and the number of non-robots placed in all elevator cars in the building, as calculated based on image information recognized by the first imaging device.

3. The elevator system according to claim 1, wherein the image unit transmits, to the first controller, at least one of: the number of robots waiting in an elevator hall in front of a specific elevator line on a specific floor; the number of non-robots waiting in the elevator hall in front of the specific elevator line on the specific floor; the number of robots waiting in all elevator halls on the specific floor; the number of non-robots waiting in all elevator halls on the specific floor; the number of robots waiting in all elevator halls on each elevator line; the number of non-robots waiting in all elevator halls on each elevator line; the number of robots waiting in all elevator halls in the building; and the number of non-robots waiting in all elevator halls in the building, as calculated based on image information recognized by the second imaging device.

4. The elevator system according to claim 1, wherein the second controller transmits, to the first controller, at least one of: the number of robots placed in a specific elevator car; the number of robots placed in all elevator cars on each elevator line; and the number of robots placed in all elevator cars in the building, as calculated based on location signals sent from the robots.

5. The elevator system according to claim 1, wherein the second controller transmits, to the first controller, at least one of: the number of robots waiting in an elevator hall in front of a specific elevator line on a specific floor; the number of robots waiting in all elevator halls on the specific floor; the number of robots waiting in all elevator halls on each elevator line; and the number of robots waiting in all elevator halls in the building, as calculated based on location signals sent from the robots.

6. A method of controlling the elevator system according to claim 1, wherein the first controller adjusts the number of serviceable robots for each floor of the building based on the number of robots or non-robots received from the image unit, when there is a difference between the number of robots or non-robots received from the image unit and the number of robots or non-robots received from the second controller.

7. A method of controlling the elevator system according to claim 1, wherein the first controller switches an operation mode of the elevator line according to the number of robots or non-robots received from the image unit, when there is a difference between the number of robots or non-robots received from the image unit and the number of robots or non-robots received from the second controller.

8. The method according to claim 7, wherein, in a state that a specific elevator line is operated in the robot exclusive mode, when the number of robots received from the image unit indicates that there is neither a robot waiting in any elevator hall on the entire corresponding elevator line nor a robot placed inside any elevator car on the entre corresponding elevator line for a certain period of time or more, the first controller switches the corresponding elevator line to the boarding-share mode.

9. The method according to claim 8, wherein, in a state that the corresponding elevator line is switched from the robot exclusive mode to the boarding-share mode by the first controller, when the number of non-robots received from the image unit indicates that there is neither a non-robot waiting in any elevator hall on the entire corresponding elevator line nor a non-robot placed inside any elevator car on the entire corresponding elevator line for a certain period of time or more, the first controller returns the corresponding elevator line from the boarding-share mode to the robot exclusive mode.

10. The method according to claim 7, wherein, in a state that a specific elevator line is operated in the non-robot exclusive mode, when the number of non-robots received from the image unit indicates that there is neither a non-robot waiting in any elevator hall on the entire corresponding elevator line nor a non-robot placed inside any elevator car on the entire corresponding elevator line for a certain period of time or more, the first controller switches the corresponding elevator line to the boarding-share mode.

11. The method according to claim 10, wherein, in a state that the corresponding elevator line is switched from the non-robot exclusive mode to the boarding-share mode by the first controller, when the number of robots received from the image unit indicates that there is neither a robot waiting in any elevator hall on the entire corresponding elevator line nor a robot placed inside any elevator car on the entire corresponding elevator line for a certain period of time or more, the first controller returns the corresponding elevator line from the boarding-share mode to the non-robot exclusive mode.
